(19) United States
(12) Patent Application Publication
(10) Pub. No.: US 2022/0075198 A1
(43) Pub. Date: Mar. 10, 2022

(54) GLASSES TYPE DISPLAY DEVICE AND LIGHT-SHIELDING FACE MASK

(71) Applicant: HTC Corporation, Taoyuan City (TW)

(72) Inventors: Ching-Ho Li, Taoyuan City (TW); Wei-Cheng Liu, Taoyuan City (TW); Chun-Lung Chu, Taoyuan City (TW)

(73) Assignee: HTC Corporation, Taoyuan City (TW)

(21) Appl. No.: 17/338,677

(22) Filed: Jun. 4, 2021

Related U.S. Application Data
(60) Provisional application No. 63/075,212, filed on Sep. 7, 2020.

(51) Int. Cl. G02B 27/01; G02C 5/12

(52) U.S. Cl. CPC G02B 27/0176; G02B 2027/0178; G02C 5/12; G02B 27/0172

(57) ABSTRACT

A glasses type display device includes a front end assembly, a pair of legs and a light-shielding mask. Each of the pair of legs includes a front segment and a rear segment. The front segment is coupled to the front end assembly. The rear segment is pivotally connected to the corresponding front segment on an axis. The light-shielding mask includes a frame and a cover. The frame is connected to the front end assembly. The cover has flexibility and is connected to the frame to cover the eyes of the user. The movement range of the rear segment relative to the corresponding front segment partially overlaps with the cover in space.

### CROSS-REFERENCE TO RELATED APPLICATION

This application claims the priority benefit of U.S. provisional application Ser. No. 63/075,212, filed on Sep. 7, 2020. The entirety of the above-mentioned patent application is hereby incorporated by reference herein and made a part of this specification.

### BACKGROUND

### Technology Field

The application relates to a display device, and in particular to a glasses type display device and a light-shielding mask thereof.

### Description of Related Art

Currently, a more common type of display device used in virtual reality is a head-mounted display device, but this type of head-mounted display device is considerably heavy and the wearing process is relatively cumbersome. Therefore, display devices used in virtual reality are moving towards the development of lightweight and easily wearable design, and glasses type display devices is one of the development directions.

### SUMMARY

The application provides a glasses type display device with functions of folding legs and shielding light.

The application provides a light-shielding mask used in a glasses type display device and having a light-shielding function without affecting the folding of the legs.

The glasses type display device of the application includes a front end assembly, a pair of legs, and a light-shielding mask. Each of the pair of legs includes a front segment and a rear segment. The front segment is coupled to the front end assembly. The rear segment is pivotally connected to the corresponding front segment on an axis. The light-shielding mask includes a frame and a cover. The frame is connected to the front end assembly. The cover has flexibility and is connected to the frame for covering the eyes of a user. The movement range of the rear segment relative to the corresponding front segment partially overlaps with the cover in space.

The light-shielding mask of the application is adapted for a glasses type display device. The glasses type display device includes a front end assembly and a pair of legs. Each of the pair of legs includes a front segment and a rear segment. The front segment is coupled to the front end assembly. The rear segment is pivotally connected to the corresponding front segment on an axis. The light-shielding mask includes a frame and a cover. The frame is connected to the front end assembly. The cover has flexibility and is connected to the frame for covering the eyes of a user. The movement range of the rear segment partially overlaps with the cover in space.

Based on the above, in the application, the light-shielding mask adopts a flexible cover, which not only provides a light-shielding function but also allows the legs to be folded and squeezed into the cover. Therefore, when the legs are in the folded state, the glasses type display device adopting the light-shielding mask can have a relatively small volume.

### BRIEF DESCRIPTION OF THE DRAWINGS

FIG. 1 is a schematic view illustrating a glasses type display device according to an embodiment of the invention.

FIG. 2 is a schematic view illustrating the glasses type display device of FIG. 1 from another viewing angle.

FIG. 3 is a schematic view illustrating the glasses type display device of FIG. 2 when the legs are folded.

FIG. 4 is an exploded view of the glasses type display device of FIG. 2.

FIG. 5 is an exploded view of the light-shielding mask of FIG. 4.

FIG. 6 is a schematic view illustrating the glasses type display device of FIG. 2 in a top view of the legs.

FIG. 7 is an exploded view of a light-shielding mask according to another embodiment of the invention.

FIG. 8 is a schematic view illustrating a light-shielding mask according to another embodiment of the invention.

FIG. 9 is a schematic view illustrating a frame of a light-shielding mask according to another embodiment of the invention.

### DESCRIPTION OF THE EMBODIMENTS

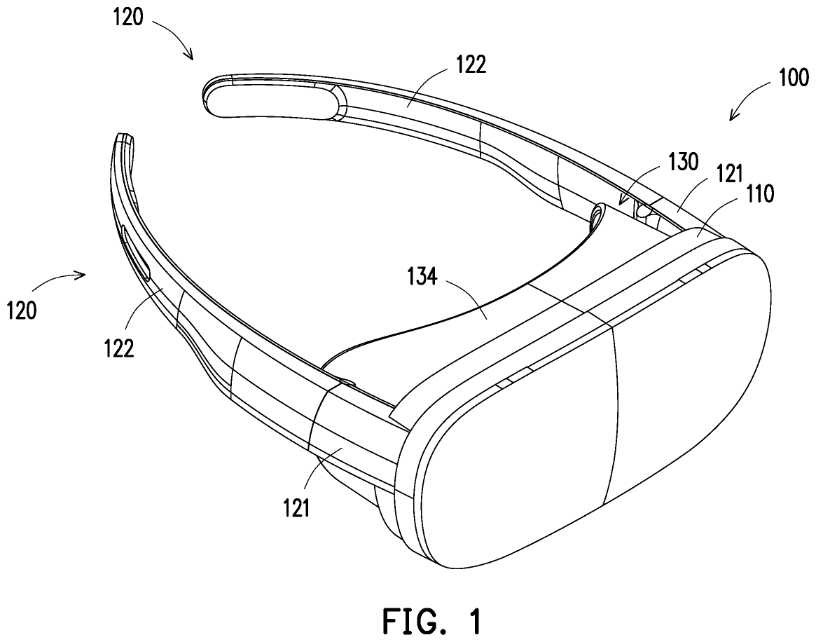

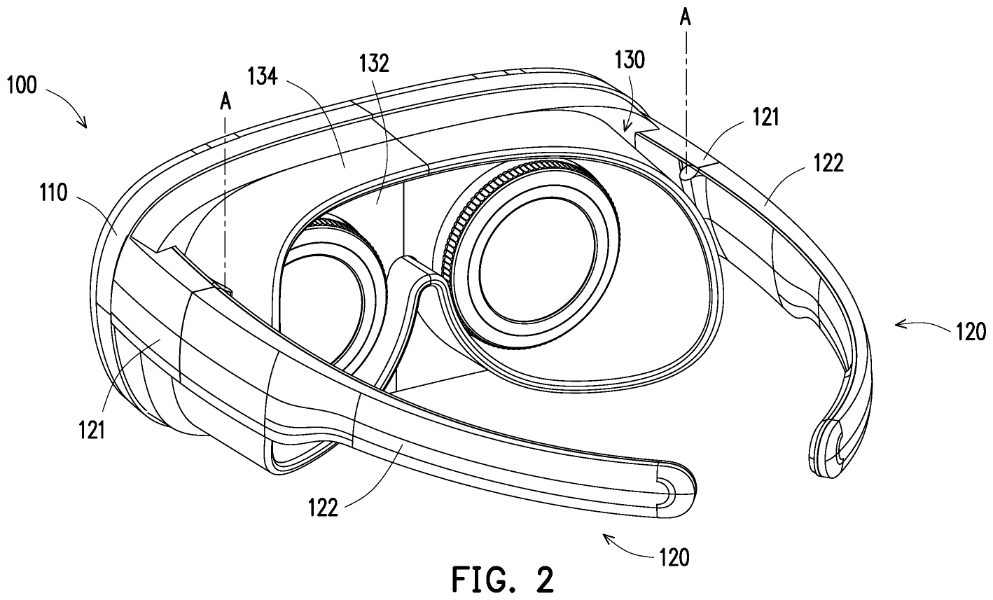

Referring to FIG. 1 and FIG. 2, in an embodiment of the invention, a glasses type display device 100 includes a front end assembly 110. The front end assembly 110 may include components, such as an optical system (not shown), a protective housing, and the like; and a display may be disposed therein or a display may be adapted to be disposed therein. The display may be a built-in display or an external portable display (e.g., a smart phone and the like.), but the application is not limited thereto. The type of the display may vary according to the application of the glasses type display device 100 in a virtual reality system, in an augmented reality system, or in a mixed reality system. The optical system includes optical components, such as a lens, a light guide, or a prism, used to change the optical path of the display.

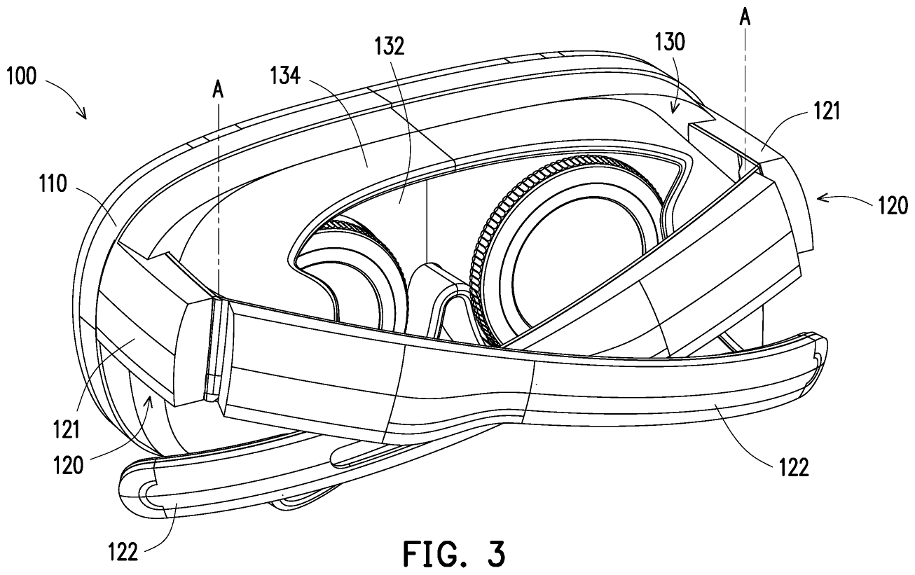

Referring to FIG. 2 and FIG. 3, the glasses type display device 100 includes a pair of legs 120. Each of the legs 120 may include a front segment 121 and a rear segment 122. The front segment 121 is coupled to the front end assembly 110, and the rear segment 122 is pivotally connected to the corresponding front segment 121 along an axis A. Therefore, when the rear segment 122 of each of the legs 120 pivots to be close to the front end assembly 110 relative to the corresponding front segment 122, the glasses type display device 100 takes up much less space, contributing to the storage of the glasses type display device 100. In the embodiment, the front segment 121 may be detachably assembled to the front end assembly 110. Alternatively, the front segment 121 may also be pivotally connected to the front end assembly 110. Alternatively, the front segment 121 and the front end assembly 110 may also be integrated.

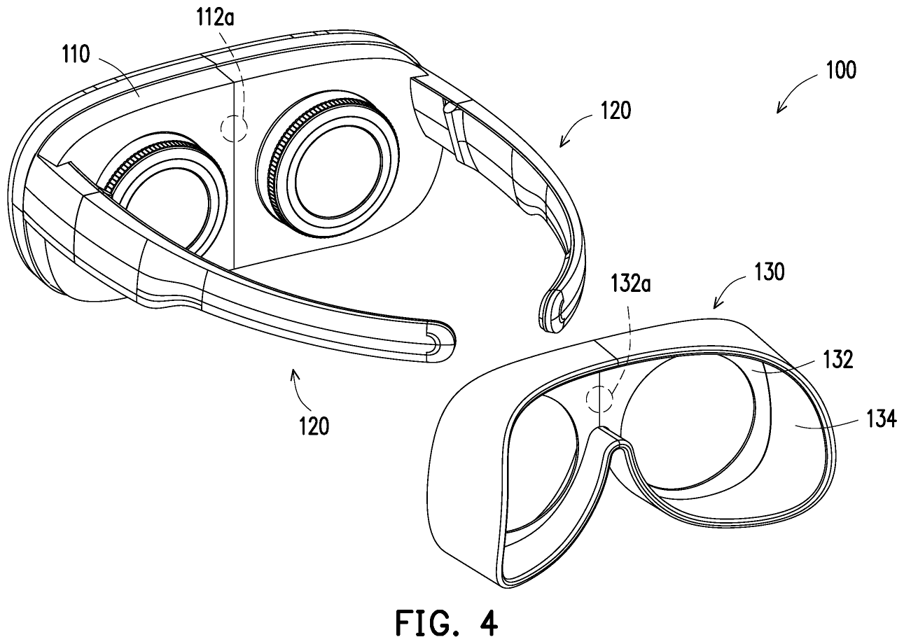

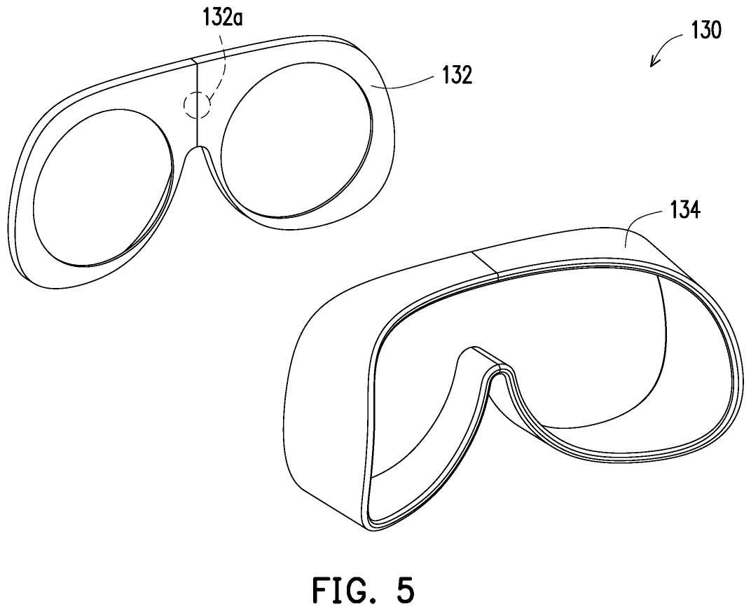

Referring to FIG. 4 and FIG. 5, the glasses type display device 100 includes a light-shielding mask 130. The light-shielding mask 130 may be connected to the front end assembly 110. Therefore, the light-shielding mask 130 can cover the eyes of the user when in use, and the influence of external light is reduced. In the embodiment, the light-shielding mask 130 includes a frame 132 and a cover 134. The frame 132 is connected to the front end assembly 110. The cover 134 has flexibility and is connected to the frame 132 for covering the eyes of the user. The movement range of the rear segment 122 relative to the corresponding front segment 121 partially overlaps with the cover 134 in space. In the embodiment, the material of the frame 132 may be plastic, for example; and the material of the cover 134 may be sponges, foamed materials, or other flexible materials, for example. However, the application is not limited thereto.

Referring to FIG. 2 and FIG. 3, the cover 134 can be squeezed to deform along with the corresponding legs 120 when the pair of legs 120 are in a folded state (as shown in FIG. 3). In other words, the movement range of the rear segment 122 relative to the corresponding front segment 121 partially overlaps with the cover 134 in space. Then, when the pair of legs 120 are in an unfolded state (as shown in FIG. 2) relative to the front end assembly 110, the cover 134 returns to its original shape substantially and becomes adapted to the shape of the eyes of the user when in use, so that external light can be shielded as much as possible.

Besides providing a light-shielding effect, the flexible cover 134 also provides the effect of supporting the front end assembly 110. Specifically, the upper side of the cover 134 may abut against the upper side of the eyes of the user, such as the frontal bone of the user. The lower side of the cover 134 can abut against the lower side of the eyes of the user, such as the cheekbones of the user. Specifically, the lower side of the cover 134 can abut against the lower side of the eyes of the user, so the pressure from the glasses type display device 100 on the nose of the user can be reduced, and the user comfort is improved. The opposite sides of the cover 134 can abut against the opposite sides of the eyes of the user, such as the eye tails of the user.

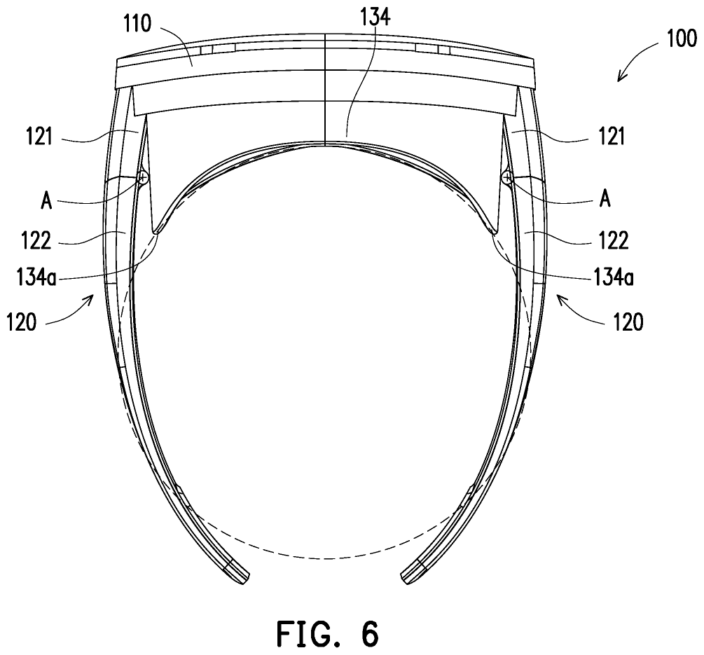

Referring to FIG. 6, in the embodiment, an end 134a of the cover 134 covering the eye tails of the user is farther away from the front end assembly 110 than the axis A. The dotted line in FIG. 6 indicates the head position of the user. Specifically, the cover 134 is flexible, so the cover 134 can cover the eye tails of the user, and external light getting into the space between the face of the user and the cover 134 can be reduce, that is, light leakage is reduced. The cover 134 is flexible, so the cover 134 can be squeezed by the rear segment 122 of each of the legs 120 when the rear segment 122 of each of the legs 120 pivots to be close to the front end assembly 110 relative to the corresponding front segment 122, so that the glasses type display device 100 takes up much less space.

Referring to FIG. 4 again, in the embodiment, the frame 132 is detachably connected to the front end assembly 110. Specifically, the frame 132 has a detachable connecting portion 132a to be detachably connected to a corresponding connecting portion 112a of the front end assembly 110. The detachable connecting portion 132a and the corresponding connecting portion 112a are a pair of magnets or a pair of fasteners, for example, and the frame 132 can be mounted to the front end assembly 110 by a magnetic force or clamping. Therefore, the detachable light-shielding mask 130 can be washed separately, making it easier to clean the light-shielding mask 130. Moreover, it is allowed for users to replace the detachable light-shielding mask 130, so the outlook and mode of the light-shielding mask 130 can be varied in more ways.

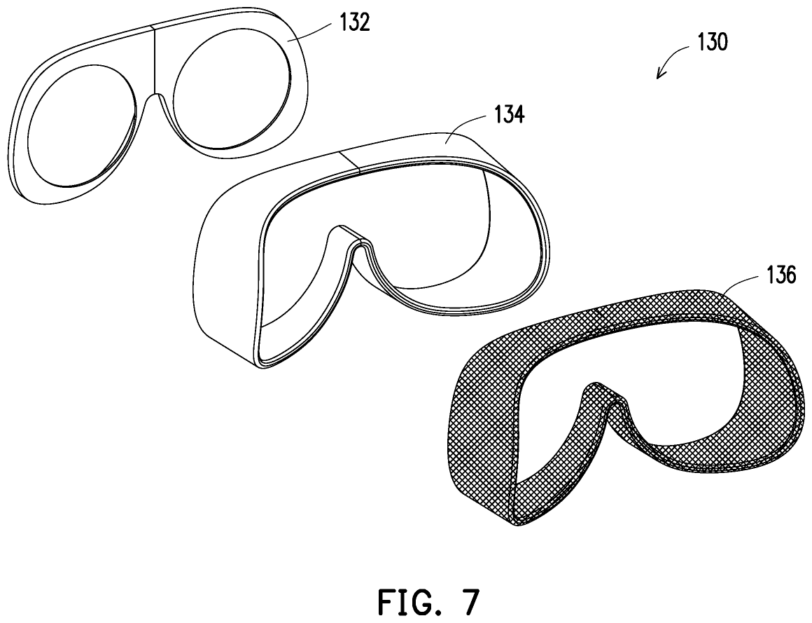

Referring to FIG. 7, compared to the embodiment of FIG. 5, in the embodiment, the light-shielding mask 130 further includes a sleeve 136. The sleeve 136 covers the cover 134. The material of the sleeve 136 may be a textile material, but the application is not limited thereto.

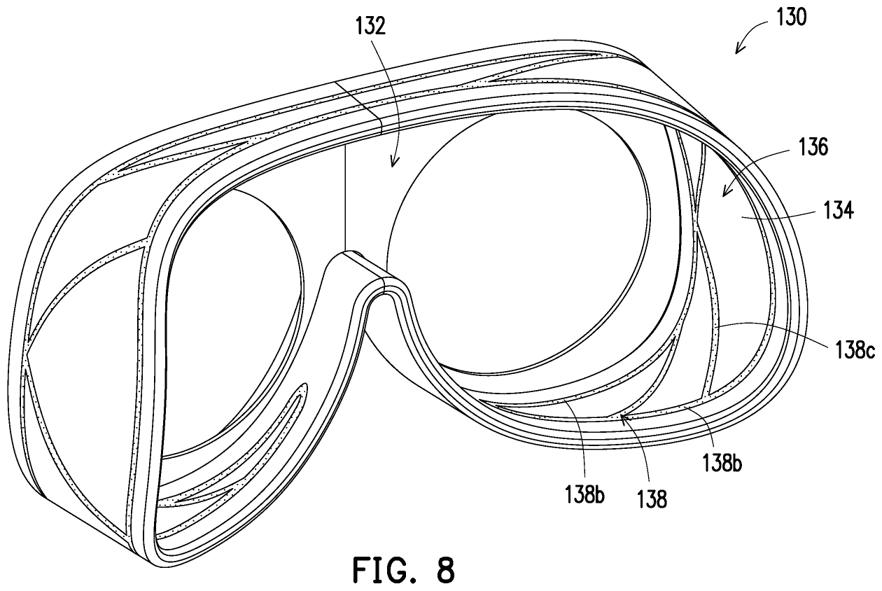

Referring to FIG. 8, compared to the embodiment of FIG. 5, in the embodiment, the light-shielding mask 130 further includes multiple ribs 138. The ribs 138 are distributively disposed on the cover 134 or the sleeve 136. The ribs 138 include a front rib 138a, a rear rib 138b, and multiple connecting ribs 138c; and the connecting ribs 138c extend in a tilted manner between the front rib 138a and the rear rib 138b. The ribs 138 may be a patterned plastic sheet attached to the cover 134 or the sleeve body, but the application is not limited thereto. When the legs 120 are folded, the ribs 138 can deform along with the cover 134 and the sleeve. When in use, the ribs 138 can generate rigidity for abutting against the face of the user, so the nose discomfort of the user is reduced.

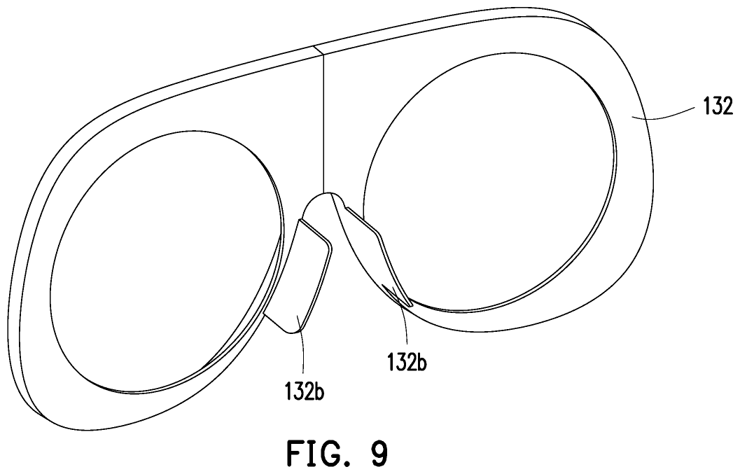

Referring to FIG. 9, compared to the embodiment of FIG. 5, in the embodiment, the frame 132 includes a pair of nose pads 132b for abutting against the nose of the user.

Based on the above, in the embodiments of the application, the light-shielding mask adopts a flexible cover, which not only provides a light-shielding function but also allows the legs to be folded and squeezed into the cover. Therefore, when the legs are in the folded state, the glasses type display device adopting the light-shielding mask can have a relatively small volume. Moreover, the light-shielding mask is detachably connected to the front end assembly, so the light-shielding mask can be washed separately and replaced at will. Also, the ribs on the cover or the sleeve can generate rigidity for abutting against the face of the user, and the nose discomfort of the user is reduced.

What is claimed is:

1. A glasses type display device, comprising:
a front end assembly;
a pair of legs, wherein each of the pair of the legs comprises:
a front segment coupled to the front end assembly; and
a rear segment pivotally connected to the corresponding front segment on an axis; and
a light-shielding mask comprising:
a frame connected to the front end assembly; and
a cover having flexibility and connected to the frame for covering eyes of a user, wherein a movement range of the rear segment relative to the corresponding front segment partially overlaps with the cover in space.

2. The glasses type display device of claim 1, wherein the frame comprises a detachable connecting portion detachably connected to a corresponding connecting portion of the front end assembly.

3. The glasses type display device of claim 1, wherein the light-shielding mask further comprises:
a sleeve covering the cover.

4. The glasses type display device of claim 1, wherein the light-shielding mask further comprises:
a plurality of ribs distributively disposed on the cover.

5. The glasses type display device of claim 4, wherein the plurality of ribs comprise a front rib, a rear rib, and a plurality of connecting ribs, and the plurality of connecting ribs extend in a tilted manner between the front rib and the rear rib.

6. The glasses type display device of claim 1, wherein the frame comprises a pair of nose pads for abutting against a nose of the user.

7. The glasses type display device of claim 1, wherein an end of the cover covering eye tails of the user is farther away from the front end assembly than the axes.

8. A light-shielding mask adapted for a glasses type display device, wherein the glasses type display device comprises a front end assembly and a pair of legs, each of the pair of the legs comprises a front segment and a rear segment, the front segment is coupled to the front end assembly, the rear segment is pivotally connected to the corresponding front segment on an axis, and the light-shielding mask comprises:
a frame connected to the front end assembly; and
a cover having flexibility and connected to the frame for covering eyes of a user, wherein a movement range of the rear segment relative to the corresponding front segment partially overlaps with the cover in space.

9. The light-shielding mask of claim 8, wherein the frame comprises a detachable connecting portion detachably connected to a corresponding connecting portion of the front end assembly.

10. The light-shielding mask of claim 8, further comprising:
a sleeve covering the cover.

11. The light-shielding mask of claim 8, further comprising:
a plurality of ribs distributively disposed on the cover.

12. The light-shielding mask of claim 11, wherein the plurality of ribs comprise a front rib, a rear rib, and a plurality of connecting ribs; and the plurality of connecting ribs extend in a tilted manner between the front rib and the rear rib.

13. The light-shielding mask of claim 8, wherein the frame comprises a pair of nose pads for abutting against a nose of the user.
